(19) United States
(12) Patent Application Publication
(10) Pub. No.: US 2005/0218724 A1
(43) Pub. Date: Oct. 6, 2005

(54) Converter containing time sequence

(76) Inventor: Zhiping Zhang, Beijing (CN)

Correspondence Address: Zhang Zhiping, Anhuaxili, Block 2, Bldg 5, 2-101, Beijing, 100011, CN

(21) Appl. No.: 11/092,951

(22) Filed: Mar. 30, 2005

(30) Foreign Application Priority Data
Apr. 5, 2004 (CN) 200410029931.0

(51) Int. Cl. H02J 1/00

(52) U.S. Cl. 307/39

(57) ABSTRACT

A design method for solid state converters. Denial and give up self excited converter, adopt only separate excited converter, start-stop operation of the output stage is so arranged by special means that the control voltage does earlier to start actuating and later to stop in comparing with the main loop being power switched on and off. Or put a frequent switch on the main loop, keeping control voltage non-stop actuating.

### BACKGROUND OF THE INVENTION

The present invention relates to a design method for electronic power converter featured by an on-off time sequence intentionally set in between control voltage and the main loop of the output stage of the converter.

The prior art that this invention is drawn toward exists everywhere around us. Examples that can be found at home and office are millions of personal computers with a power converter as an internal unit in PC, which is exampled as in a Chinese book “The Principle and Inspection of Multi-frequency Color Display”, P73, PHEI, 2000.5, ISBN7-5053-5481-7/TN.1294. Also found are the electronic ballast of fluorescent lamp and the electromagnet stove. All of those involve solid-state converters and almost all are self-excited converter.

The manufacturers always advise the users that never frequently switch it on and off. Even so, causeless damage often happens with breakdown of power device in the output stage of the converter. Famous branded manufacturers by no means but generally take even higher safety coefficient in selecting power device, to get lesser trouble rate.

The present invention gives an effective and low cost solution as follows.

### BRIEF SUMMARY OF THE INVENTION

The breakdown of power device of output stage in a converter could be mechanically analysed for the cause in many possible reasons. The present invention targets and focuses the reason being simply the unsaturated conduction-on state during a short period of time when the device is driven on soon after the mains switch is turned on and when the device is driven off soon after the mains off when residual energy in form of both magnet and electric charge is being exhausted to zero.

In this connection, the present invention emphasizes that the self excited converter with it's power device is driven by control voltage so as to generate output current; and part of the output current is fed back, in a correct phase, to act as the control voltage actuating to the input port in a reciprocate process. There must be several cycles of reciprocity when the power device is doing utmost amplifying, but in all case the role is finite, the saturation can not be realized in one stroke, but done in several. In this period of time, the voltage drop across the power device and along the direction of main loop is big, the current can also be foreseen a big one. The power consumption relevant to the product of voltage timing current over-heats and damages the chip of the device.

Further analysis indicates that for the separate excited converter, if control voltage actuating and main loop on-off arranged without intentionally set time sequence, i.e. they happen at the same time, due to the establishment of the control voltage is time dependent, unsaturation cycles also exist. Uncaused damage is still often to happen.

To sum up, unsaturation events always happen when the converter are designed and manufactured in form of either self excited or those separate excited, in which the control voltage start-stop actuating and main loop being power switched on-off at the same time. So the present invention is for avoiding from above situation: denial and give up self excited converter, adopt only separate excited converter, start-stop operation of the output stage is so arranged by special means that the control voltage does earlier to start actuating and later to stop actuating in comparing with the main loop being power switched on and off. See FIG. 1. For those converters, which working under endless frequently switched on-off condition, put a frequent switch on the main loop of the power device but keep non-stop actuating of the control voltage exciting. In this way, the current in the main loop goes always through good switches with lowest possible Joule heat generation. The chip is always under best safety condition.

### BRIEF DESCRIPTION OF THE SEVERAL VIEWS OF THE DRAWINGS

FIG. 1 shows when the converter being switched on, the exciting should first be established in full rate prior to the main loop is power switched on—the control voltage does earlier to start actuating; when the converter being switched off, the exciting could only be ceased off awhile after the main loop is power switched off—the control voltage does later to stop actuating.

FIG. 2 shows a proposed automatic circuit, which is introduced in the next section and can be easily built by persons of ordinary skill in this pertinent art. It's able to carry out correct time sequence relevant to the present invention.

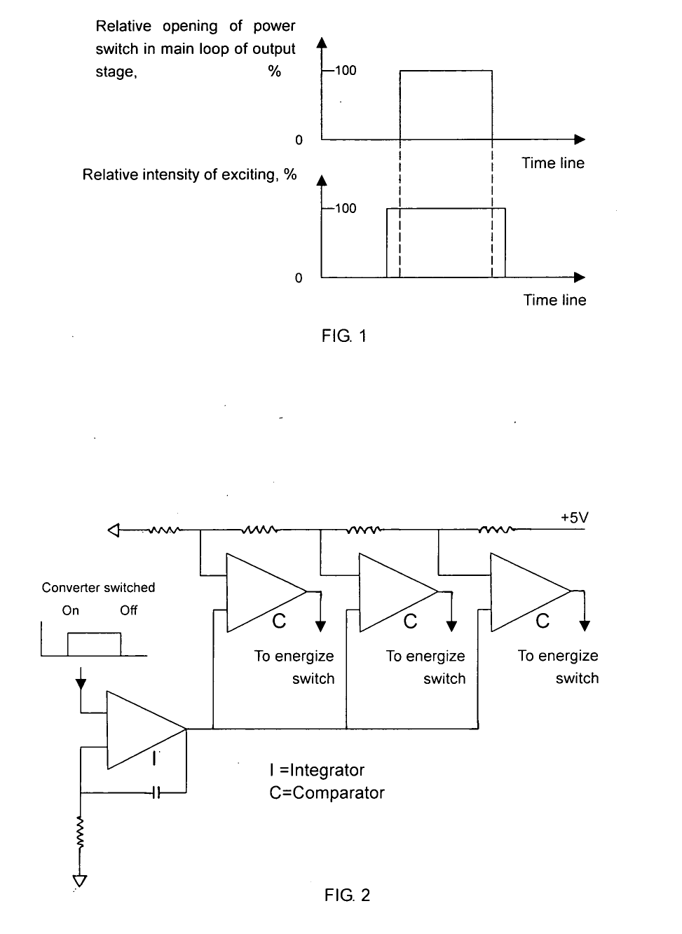

### DETAILED DESCRIPTION OF THE INVENTION

To exercise this invention, simplest way is to arrange two independent switches for exciting generator and main loop power on-off control respectively. Time sequence realized by manual operation under guidance of a document of direction. Heavy-duty converter is applicable user of this way.

More perfect arrangement is first to create an integrator that has linear increment output with an operational amplifier. Then feed the output onto each of plus input legs of any several comparators. Every minus input leg is placed on each of step-increment DC potential nodes those are from a resistor divider. Ok. When the linear output starts from zero and goes toward the upper saturation point, comparators turn over one by one in sequence and vice versa. See FIG. 2. Every turning output of comparators can be used to energize the control voltage's actuating and the main loop's on-off. Here any several comparators are mentioned rather than two, is in view of the control voltage generator that may also be a power converter, may be in need of time sequence set for safety as well.

For those converters, which working under endless frequently switched on-off condition, put a frequent switch on the main loop power line of the power device but keep non-stop actuating of the control voltage exciting.

1. A design method for solid state converters, denial and give up self excited converter, adopt only separate excited converter, start-stop operation of the output stage is so arranged by special means that the control voltage does earlier to start actuating and later to stop actuating in comparing with the main loop being power switched on and off.

2. A design method according to claim 1 wherein two functionally independent switches are used in controlling control voltage actuating and main loop being power switched on and off respectively, the time sequence of two switches is realized by either an automatic circuit or manual operation under guidance of a direction document.

3. A design method according to claim 1 wherein for those converters, which working under endless frequently switched on-off condition, put a frequent switch on the main loop power line of the output stage but keeping control voltage in non-stop actuating.
